(19) United States
(12) Patent Application Publication
(10) Pub. No.: US 2003/0157007 A1
(43) Pub. Date: Aug. 21, 2003

(54) Method and device for the catalytically treating exhaust gas containing dust and oxygen

(76) Inventors: Gurudas Samant, Fronhausen (DE); Gerd Sauter, Pappenheim (DE)

Correspondence Address: William C Gerstenzang, Norris McLaughlin & Marcus, 220 East 42nd Street, New York, NY, 10017, US

(21) Appl. No.: 10/030,198

(22) PCT Filed: Mar. 8, 2001
(86) PCT No.: PCT/EP01/02612

(51) Int. Cl. B01D 53/60

(52) U.S. Cl. 423/239.1; 422/168

(57) ABSTRACT

Process for the treatment of dust- and oxygen-containing exhaust gases which contain sulfur oxides and nitrogen oxides which comprises treating said gases in a reactor at temperatures in the range of 200° to 500° C. and in the presence of a catalyst having free opening surfaces of more than 50% and passages with a hydraulic diameter of more than 2 mm and one or more substances selected from the group consisting of free oxides, carbonates, hydroxides of calcium, magnesium, sodium and potassium and at a Froude number in the range of 1 to 100.

In chemical processes or during the combustion of fossil or secondary fuels—such as garbage or processed garbage—exhaust gases are produced, which apart from other pollutants also contain sulfur oxides and nitrogen oxides. Among experts, the sulfur oxides (SO₂ and SO₃) are referred to as SOₓ, and the nitrogen oxides (NO, NO₂ and N₂O) are referred to as NOₓ. Sulfur oxides and nitrogen oxides are gaseous pollutants which act as toxins to the environment and must therefore be removed from the exhaust gases, before the same get into the atmosphere. In the preceding years, considerable efforts were made to reduce the emissions of sulfur oxides and nitrogen oxides. In connection with the denitrification of exhaust gases several processes are being employed. The process most frequently used at present is the SCR process (SCR=Selective Catalytic Reduction). In this process, ammonia or ammonium-containing compounds are introduced into the catalyst-containing reaction chamber, and the nitrogen oxides in the flue gas are reacted to obtain nitrogen and steam. In connection with the SCR process it is reported that in the case of SO₂-containing exhaust gases sulfuric acid and ammonium hydrogen sulfate are formed. The formation of sulfuric acid and ammonium hydrogen sulfate is undesired, as in those parts of the plant which are disposed behind the reactor they lead to considerable corrosion problems. In the case of SO₂-containing exhaust gases, separate desulfurization plants are therefore generally provided before the SCR process, which desulfurization plants operate according to the principle of the dry or wet flue gas desulfurization plant (REA). In the case of wet processes, the exhaust gas is cooled and reheated for the subsequent SCR process, which is the case in most power plants and garbage incineration plants. Such processes involve high costs, and the formation of CaSO₃ corresponding to the reaction CaO+SO₂→CaSO₃ cannot be avoided. The presence of CaSO₃ in landfill materials is a hazard to the environment. EP-A-0 671 201 describes a process for separating sulfur trioxide and for denitrification—in particular in garbage incineration plants—ammonia or ammonium-containing compounds being introduced into the flue gas stream before a heat exchanger package, preferably before the last heat exchanger package, or before the flue gas cleaning, so that the catalytic denitrification of the dedusted flue gases is then effected in the low-temperature range, in particular between 100° C. and 280° C. The object is to reduce the SO₃ concentration before the SCR reactor by forming ammonium sulfate. The disadvantage of this process consists in that not only ammonium sulfate aerosols are formed, but also ammonium hydrogen sulfate, which later on is precipitated on the catalysts. The ammonium sulfate aerosols can hardly be dedusted in succeeding filter means, so that they represent a considerable burden to the environment. Moreover, a separate gas washer is necessary for the removal of SO₂. The flue gas must be reheated behind the gas washer, which is not achieved by heat exchange alone. Thus, an additional firing means, e.g. a surface burner with natural gas, is required. Disadvantages include high investment and operating costs.

It is the object underlying the invention to develop a process for the simultaneous desulfurization and denitrification without the formation of ammonium sulfate or ammonium hydrogen sulfate, wherein NOₓ is decomposed to obtain N₂ and H₂O.

This object is solved in that the treatment of the exhaust gases containing sulfur oxides and nitrogen oxides is performed in a reactor with solid catalysts in the presence of and/or with the addition of one or more substances selected from the group including free oxides, carbonates, hydroxides of calcium, magnesium, sodium and potassium, and that during the treatment the operating conditions of the gas flow in the free reaction space corresponding to the Froude numbers lie in the range of

$$1 \leq 3 / 4 \cdot \frac{{μ}^{2}}{g \cdot {d}_{k}} \cdot \frac{{ρ}_{g}}{{ρ}_{k} - {ρ}_{g}} \leq 100 with \frac{{μ}^{2}}{g \cdot {d}_{k}} = {Fr}^{2}$$

in which:

μ=the relative gas speed in m/s

Fr=the Froude number

ρ_{g}=the density of the gas in kg/m³

ρₖ=the density of the solid particle in kg/m³

dₖ=the diameter of the spherical dust particle in m

g=the gravitational constant in m/s²

Surprisingly, it was noted that despite the approximately stoichiometric operation of the NH₃/NOₓ ratios, a degree of denitrification of 95% to 98% and a degree of desulfurization of 80% to 90% can be achieved with the inventive process, the formation of ammonium sulfate, ammonium hydrogen sulfate and sulfuric acid being avoided. This advantage is based on the fact that in the catalytic treatment not only NOₓ is converted to nitrogen and steam, but also SO₂ is converted to S₃ and incorporated in the presence of free oxides, carbonates, hydroxides of calcium, magnesium, sodium and potassium. The formation of ammonium sulfates, ammonium bisulfates and sulfuric acid is suppressed. These incorporated sulfates of calcium, magnesium, sodium and potassium can very easily be separated and utilized in a succeeding filter plant, e.g. a bag collector or electrostatic precipitator.

A preferred aspect of the invention is the use of honeycomb or plate catalysts, which apart from titanium dioxide and tungsten contain more than 0.5 wt-% vanadium pentoxide. The catalytic conversion is increased. In accordance with a particularly preferred aspect of the invention, the catalysts preferably contain 2% to 8% vanadium pentoxide. With this operation, degrees of denitrification and desulfurization of more than 95% are achieved.

Another preferred aspect is the treatment in the presence of and/or with the addition of one or more substances selected from the group including free oxides, carbonates, hydroxides of calcium, magnesium, sodium and potassium, with an average particle size d₅₀ between 5 μm and 100 μm. The removal of the sulfur oxides is effected very quickly with little consumption of additives.

Furthermore, costs are preferably minimized by the treatment in the presence of and/or with the addition of one or more substances selected from the group including free oxides, carbonates, hydroxides of calcium, as calcium compounds are more economic as compared to alkali compounds.

As reducing agent, NH₃-releasing compounds such as (NH₄)₂SO₄, (NH₄)₂CO₃, (NH₄)HCO₃, (COONH₃)₂H₂O, HCOONH₄, NH₃, NH₄OH, H₂O—CO—NH₂, NH₂CN, Ca(CN)₂, NaOCN, C₂H₄N₄, C₃H₆N₆ and NH₃-containing waste waters from photochemical plants, singly or several of them, are introduced into the flue gas stream at several points in the gaseous, liquid or solid condition at temperatures in the range between 20000 and 1000° C. before entering the catalytic reactor.

A preferred aspect consists in that as reducing agent NH₃-releasing compounds in the form of dilute aqueous solutions are introduced into the flue gas stream, pref- erably at temperatures in the range between 300° C. and 550° C. The partial steam pressure in the reaction space is increased and thus the improvement of the in- corporation of sulfur is achieved.

A particularly preferred aspect of the invention is the presence or addition of one or more substances selected from the group including free oxides, carbonates, hydroxides of calcium, magnesium, sodium and potassium to the flue gas stream before the addition of NH₃-releasing compounds. The formation of ammmonium hydrogen sulfate, ammonium sulfate and sulfuric acid is suppressed completely.

Flow to the reactor can be effected from above or from below. A particularly preferred aspect of the invention consists in that the flow to the reactor equipped with the catalysts can alternately be effected from above and from below. By means of this alternate flow, the reactor can easily be kept clean of dust-laden exhaust gases, and blockage of the passages by dust can be avoided. Furthermore, the service life of the catalysts can be increased by alternating the flow to the reactor.

Another preferred aspect of the invention consists in that beside the breakdown of sulfur oxide and nitrogen oxide, the reactor equipped with catalyst can at the same time be used for the breakdown of halogen compounds, halogenated organic compounds, hydrocarbons and CO.

A preferred aspect of the invention consists in that the reactor equipped with catalyst can be used for the breakdown of sulfur oxides and nitrogen oxides in dust-laden exhaust gases in the chemical and metallurgical industries as well as in the cement and lime industries, in power plants and in garbage incineration plants in the process flow at temperatures in the range between 200° C. and 500° C. without additional preheating of the exhaust gas.

Another aspect in accordance with the invention is the apparatus for the treatment of exhaust gas containing dust and oxygen. The drawings represent examples of the apparatus for performing the process, which are explained in detail below. In the drawings:

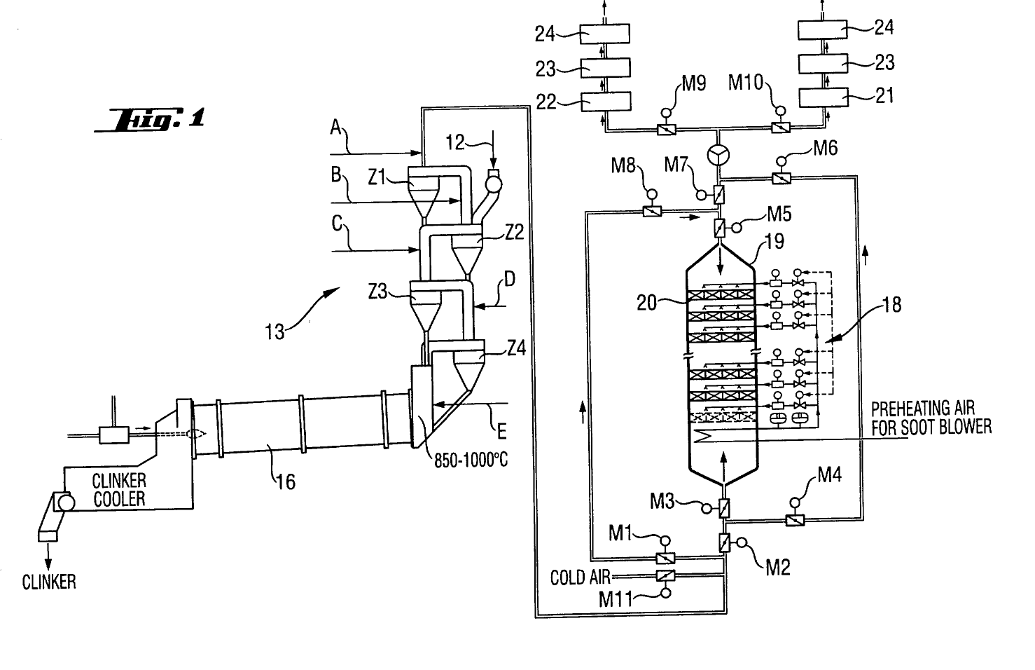

FIG. 1 schematically shows an arrangement of the apparatus in the cement industry;

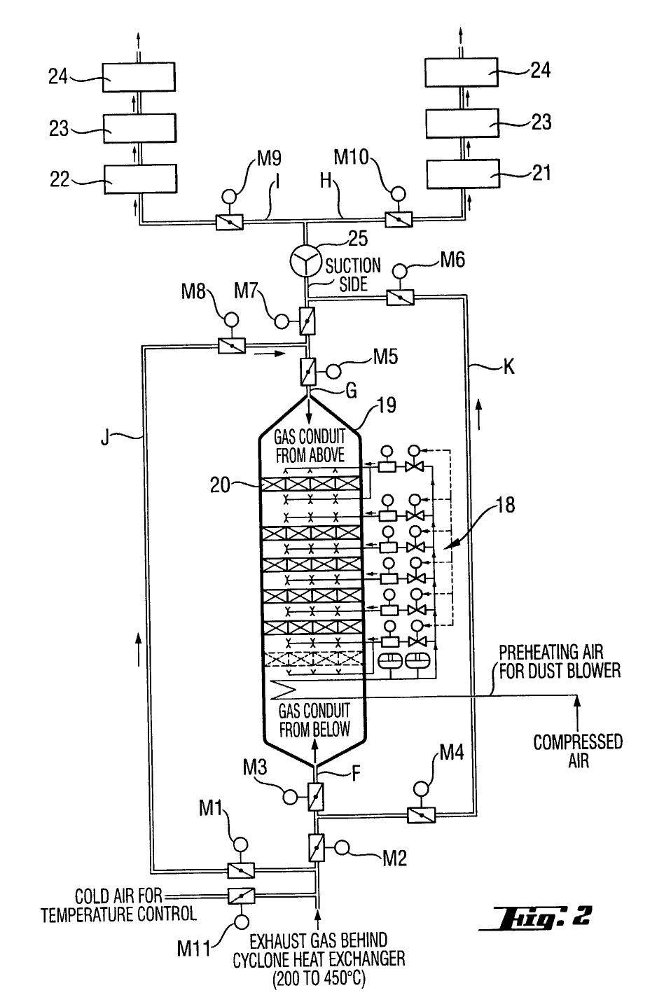

FIG. 2 schematically shows an apparatus for the cement industry;

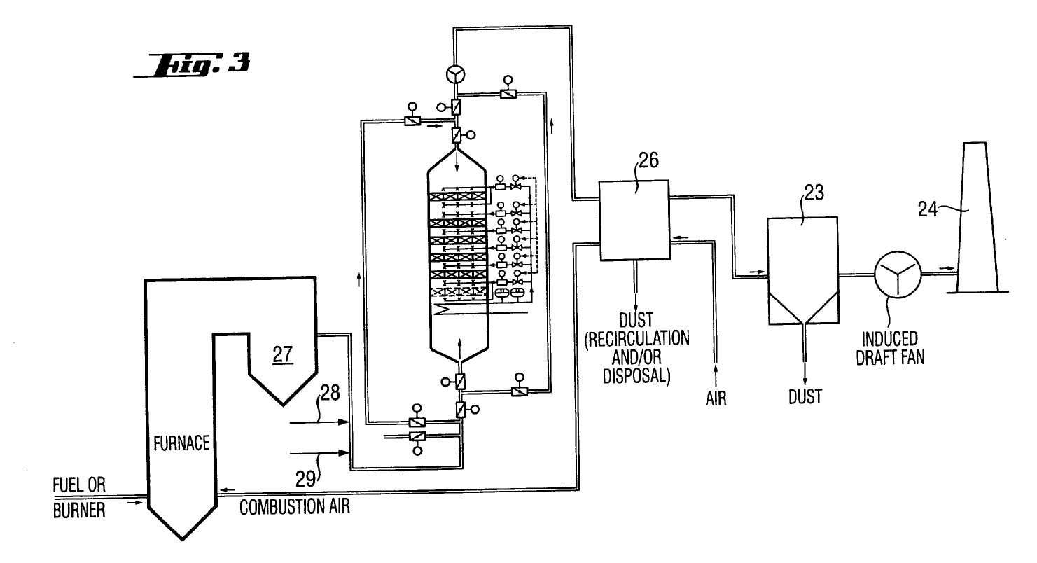

FIG. 3 schematically shows an arrangement of the apparatus for power plants;

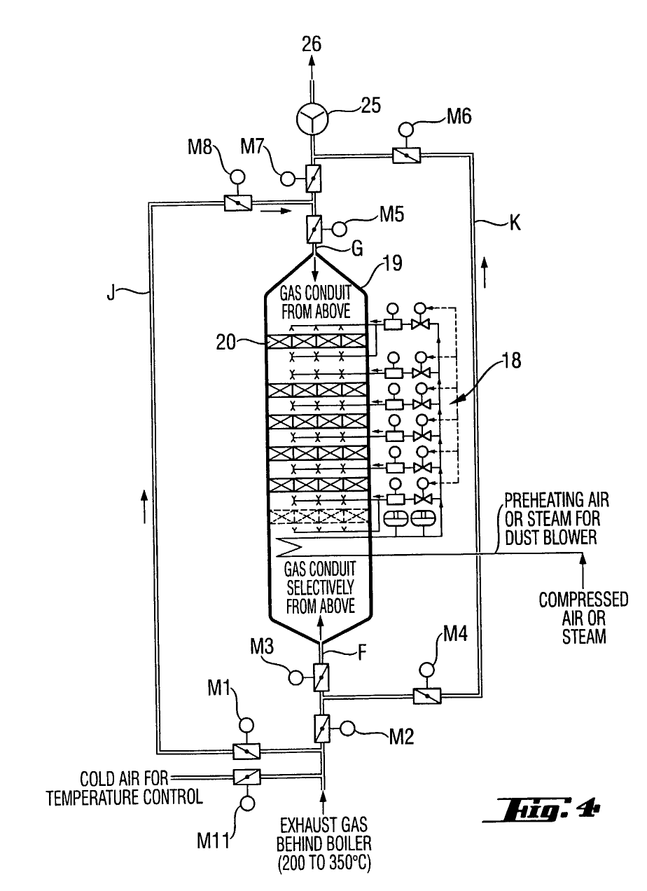

FIG. 4 schematically shows an apparatus for power plants.

FIG. 1 shows the arrangement of the inventive apparatus in a cement factory with rotary kiln 16 for the production of clinker. The SCR reactor 19 with catalyst modules 20 and dust blowers 18 is arranged in flow direction behind the suspension-type cyclone heat exchanger 13 comprising the cyclones Z1 to Z4 which are connected with each other. For metering NH₃-releasing compounds, a plurality of points A, B, C, D and E are provided at temperatures in the range from 300° C. to 1000° C. For metering ammonia, ammonia solution or urea solution, the metering points A, B and C are preferred. For metering NH₃-containing waste water from phototechnical plants and other compounds of NH₃, the metering points D and E are preferably used. The calcium-containing raw meal 12 is charged between the cyclones Z1 and Z2. After the treatment in the SCR reactor 19, the exhaust gas is either supplied to the chimney 24 via the raw material grinder 21 and the dedusting means 23 in the case of a combined operation, or is supplied to the chimney 24 via the evaporative cooler 22 and the dedusting means 23 in the case of a direct operation.

FIG. 2 shows an apparatus with gas conduit from the bottom to the top, from the top to the bottom and alternately from below and from above.

For an alternate gas conduit from below and from above in operation, some additional lines and flaps are provided, which are shown in FIG. 2. When alternately switching the exhaust gases from the bottom to the top, calcium-containing compounds and NH₃-containing exhaust gas are introduced into the reactor 19 from below via line F and are withdrawn via line G. The flaps M1, M4, M6 and M8 remain closed, and the flaps M2, M3, M5 and M7 remain open. In the case of a combined operation, the exhaust gas is then passed via the WT blower 25 and line H to the raw material grinder 21 and the dedusting means 23 to the chimney 24, or in the case of a direct operation via line I to the evaporative cooler 22 and the dedusting means 23 to the chimney 24. The flaps M9 and M10 mutually act to block the combined operation or the direct operation. When alternately switching the gas conduit from above, calcium compounds and NH₃-containing exhaust gas are introduced into the SCR reactor 19 from above via lines J and G behind the cyclone heat exchanger 13, and are discharged from below via lines F and K to the WT blower 25. The flaps M1, M8, M5, M3, M4 and M6 remain open, and the flaps M2 and M7 remain closed. In the case of a combined operation, the exhaust gas is then passed through the WT blower 25 via line H to the raw material grinder 21 and the dedusting means 23 to the chimney 24, or in the case of a direct operation via line I to the evaporative cooler 22 and the dedusting means 23 to the chimney 24.

In the case of an accident or shut-down of the SCR reactor 19, the addition of NH₃-releasing compounds is stopped and discharged via a bypass, i.e. via line K through the WT blower 25 either to the raw material grinder 21 or to the evaporative cooler 22. The flaps M2, M4, M6 remain open and the flaps M3, M1, M8, M7 and M5 remain closed. The cold-air flap M11 is provided to control the exhaust gas temperature before the SCR reactor 19.

In the case of a design with gas conduit only from below, line J and the flaps M1, M8 and M7 are superfluous and thus the apparatus is only provided with an SCR reactor 19, bypass line K and the flaps M3, M4, M5, M6. In connection with space and cost savings, two individual flaps may be equipped with a switching flap. In addition, the WT blower 25 may be installed shortly behind the cyclone heat exchanger 13, depending on space requirements and design.

For instance, the SCR reactor 19 is provided with five catalyst layers with modules for the breakdown of SOₓ and NOₓ and one catalyst layer with modules for the breakdown of hydrocarbons and carbon monoxide. Depending on the content of SOₓ, NOₓ, hydrocarbons and carbon monoxide, the number of catalyst layers may be changed. On the gas side, the catalyst elements or catalyst modules 20 are provided with a protection against wear or with antiwear grids made of hard metal or ceramics against the erosion of dust-laden exhaust gases. In the case of an alternate gas conduit from above and from below, a protection against wear of about 5-20 mm is mounted on both sides.

For cleaning the catalyst surface, dust blowers 18 are furthermore provided for each catalyst layer on the gas side. In the case of an alternate gas conduit in operation from above and from below, the dust blowers 18 are provided on both sides. Before entering the reactor 19, the air for the dust blowers 18 is heated to about 250° C.

FIG. 3 shows the arrangement of the inventive apparatus for power plants between boiler 27 and air preheater 26. Additives 28, e.g. Ca(OH)₂, are added behind the boiler 27 and before the NHOH dosage 29.

FIG. 4 shows the gas conduit from below or from above or in an alternate operation from below and from above analogous to the description given in FIG. 2 for cement factories. In power plants, as compared to cement factories, the exhaust gas is supplied behind the SCR reactor 19 via the air preheater 26 and the dedusting means 23 to the chimney 24.

The process in accordance with the invention will be explained below with reference to embodiments.

In a cement factory with an exhaust gas volume of 100000 m³_{N.tr}/h a system is installed as it is shown in FIG. 2. Experiments are made with partial gas streams of 3000-10000 m³_{N.tr}. Before being introduced into the reactor, the raw gas has the following composition:

NOₓ content (calculated as NO₂)=1500 mg/m³_{N. tr}

SO₂ content=500 mg/m³_{N.tr}

dust content=8000 mg/m³_{N.tr}

O₂ content=3.2 vol-%

Temperature in the reactor=320° C.

The density of the gas is calculated with reference to the gas composition. The dust content before entrance into the reactor (chiefly CaO and Ca(OH)₂) is 8000 mg/m³_{N.tr}. The determined particle density of the dust is about 3.1 kg/M³. With reference to these data and operating conditions, a gas speed of 6.5 m/s is determined corresponding to the Froude numbers.

In the experiments, there were used honeycomb catalysts with different contents of active components and with the following specifications:

free opening surface=85%

pitch=11 mm

clear width of the passages=10 mm

wall thickness=1 mm.

The content of active component (e.g. V₂O₅) in the catalysts is 0.1%, 0.3%, 1%, 3% and 5%. As reducing agent, gaseous NH₃ with a stoichiometry, i.e. a molar ratio NH₃/NOₓ of 0.85 is added before entry in the reactor.

For the experiments, a steel grid made of stainless steel is mounted on the module of the catalyst as a protection against wear before entry of the dust-laden exhaust gas.

The gas components NOₓ, SOₓ, NH₃, CO, CO₂ and H₂O are measured continuously before and behind the reactor by means of a multicomponent analyzer MCS-100.

The breakdown of the most important components in dependence on the content of active component V₂O₅ is represented in the following Table:

| Active component of | Breakdown of | Breakdown of | Breakdown of |
|---|---|---|---|
| the catalyst | NOₓ | SOₓ | hydrocarbons |
| V₂O₅ content 0.1% | 34 | 3 | 10 |
| V₂O₅ content 0.3% | 42 | 5 | 15 |
| V₂O₅ content 1.0% | 56 | 22 | 30 |
| V₂O₅ content 3.0% | 75 | 70 | 55 |
| V₂O₅ content 5.0% | 95 | 90 | 70 |

The results show that with the inventive process NOₓ and SOₓ are decomposed when suitable operating conditions—gas flow and selection of the active components—are adjusted.

In the experiments with 5% V₂O₅, the NH₃ content of the exhaust gas is about <1 mg/m³_{N.tr}. The analyses of the dust behind the catalyst exhibit no formation of ammonium sulfate, ammonium hydrogen sulfate or CaSO₃. The SOₓ content is bound as CaSO₄. Moreover, these experiments exhibit not dust deposits in the reactor or in the catalyst passages.

In another series of experiments, the operating conditions of the gas flow in the free reaction space are changed outside the inventive Froude numbers with the same gas composition, the same dust content and the same catalysts. It is noted that at gas speeds below 4 m/s the breakdown of NOₓ decreased considerably and the differential pressure at the reactor 19 increased. The result is a complete blockage of the catalyst passages with dust.

List of Reference Numbers

| | | | | | | | |
|---|---|---|---|---|---|---|---|
| A | metering point | | | 12 | raw meal addition | | |
| B | metering point | | | 13 | cyclone heat exchanger | | |
| C | metering point | {close oversize brace} | unchanged | 14 | — | | |
| D | metering point | | | 15 | — | | |
| E | metering point | | | 16 | rotary kiln | | |
| F | line | | | 17 | — | | new |
| G | line | | new | 18 | dust blower | | reference |
| H | line | | by avoiding double | 19 | SCR reactor | | numbers |
| | | {close oversize brace} | | 20 | catalyst modules | | instead of |
| I | line | | usage for various | | | {close oversize brace} | |
| J | line | | elements | 21 | raw material grinder | | legends |
| K | line | | | 22 | evaporative cooler | | in the |
| M1 | flap | | | 23 | dedusting means | | priority |
| M2 | flap | | | 24 | chimney | | drawings |
| M3 | flap | | | 25 | WT blower | | |
| M4 | flap | | modified and “M” | 26 | air preheater | | |
| M5 | flap | | extracted from the | 27 | boiler | | |
| M6 | flap | {close oversize brace} | circle symbols | 28 | additives | | |
| M7 | flap | | acc. to 37 CFR 1.84 | 29 | reducing agent | | |
| M8 | flap | | | | | | |
| M9 | flap | | | | | | |
| M10 | flap | | | | | | |
| M11 | flap | | | | | | |

Note:
All corrections in the drawings and the claims were executed without including any “matter” according to 35 U.S.C. 113 ff.

1. A process for the treatment of dust- and oxygen-containing exhaust gases, which contain sulfur oxides and nitrogen oxides, at temperatures in the range from 200° C. to 500° C. by means of reducing agents in a reactor (19) which is equipped with solid catalyst (20) with flow passages, in which the free opening surface of the catalyst (20) is more than 50% and in which the passages of the catalyst (20) have a hydraulic diameter of more than 2 mm, characterized in that
a) the treatment in the reactor (19) is performed in the presence of and/or with the addition of one or more substances selected from free oxides, carbonates, hydroxides of calcium, magnesium, sodium and potassium,
b) during the treatment, the operating conditions of the gas flow in the free reaction space are adjusted corresponding to the Froude numbers in the range of
$$1 \leq 3 / 4 \cdot \frac{{μ}^{2}}{g \cdot {d}_{k}} \cdot \frac{{ρ}_{g}}{{ρ}_{k} - {ρ}_{g}} \leq 100 with \frac{{μ}^{2}}{g \cdot {d}_{k}} = {Fr}^{2} .$$

2. The process as claimed in claim 1, characterized in that in the reactor (19) honeycomb and/or plate catalysts (20) are used, which beside titanium dioxide and tungsten contain more than 0.5wt-%, preferably 2-8 wt-%, vanadium pentoxide.

3. The process as claimed in any of claims 1 and 2, characterized in that the treatment is performed in the presence of and/or with the addition of one or more substances selected from free oxides, carbonates, hydroxides of calcium, magnesium, sodium and potassium with an average particle size d₅₀ between 5 μm and 100 μm.

4. The process as claimed in any of claims 1 to 3, characterized in that the treatment of the exhaust gas is preferably performed in the presence of and/or with the addition of one or more substances selected from free oxides, carbonates, hydroxides of calcium.

5. The process as claimed in any of claims 1 to 4, characterized in that as reducing agent there are used NH₃-releasing compounds such as (NH₄)₂SO₄, (NH₄)₂CO₃, (NH₄)HCO₃, (COONH₃)₂H₂O, HCOONH₄, NH₃, NH₄OH, H₂O—CO—NH₂, NH₂CN, Ca(CN)₂, NaOCN, C₂H₄N₄, C₃H₆N₆ and NH₃-containing waste waters from photochemical plants, singly or several of them.

6. The process as claimed in claim 5, characterized in that before entry of the exhaust gases in the reactor (19), the NH₃-releasing compounds are incorporated in the flue gas stream in the gaseous, liquid or solid condition at temperatures in the range between 200° C. and 1000° C.

7. The process as claimed in any of claims 5 and 6, characterized in that the NH₃-releasing compounds are incorporated in the flue gas stream in the form of dilute aqueous solutions at temperatures in the range between 300° C. and 550° C.

8. The process as claimed in any of claims 1 to 7, characterized in that the presence or the addition of one or more substances selected from free oxides, carbonates, hydroxides of calcium, magnesium, sodium and potassium to the flue gas stream preferably is effected before the use of NH₃-releasing compounds.

9. The process as claimed in any of claims 1 to 8, characterized in that the flow to the reactor (19) equipped with the catalyst (20) is effected from above or from below.

10. The process as claimed in any of claims 1 to 9, characterized in that the flow to the reactor (19) equipped with the catalyst (20) is effected alternately from above and from below.

11. The process as claimed in any of claims 1 to 10, characterized in that beside the breakdown of sulfur oxides and nitrogen oxides, the reactor (19) equipped with the catalyst (20) is at the same time used for the breakdown of halogen compounds, halogenated organic compounds, hydrocarbons and CO.

12. The process as claimed in any of claims 1 to 11, characterized in that the reactor (19) equipped with the catalyst (20) is used for the breakdown of sulfur oxides and nitrogen oxides in dust-laden exhaust gases in the chemical and metallurgical industries as well as in the cement and lime industries, in power plants and in garbage incineration plants in the process flow at temperatures in the range between 200° C. and 500° C. without additional preheating of the exhaust gas.

13. An apparatus for the treatment of dust- and oxygen-containing exhaust gases of a cement factory, which exhaust gases contain sulfur oxides and nitrogen oxides, characterized in that the reactor (19) equipped with catalyst (20) is disposed in the exhaust gas stream behind the cyclone heat exchanger (13) (and before the raw material grinder (21) and before the bypass I to the evaporative cooler (22)).

14. The apparatus as claimed in claim 13, characterized in that the addition of NH₃-releasing compounds to the heat exchanger preferably is effected in the vicinity of the raw meal addition (12) and/or shortly behind the raw meal addition (12), preferably before the last cyclone (Z1).

15. An apparatus for the treatment of dust- and oxygen-containing exhaust gases of a power plant, which exhaust gases contain sulfur oxides and nitrogen oxides as well as halogen compounds, halogenated organic compounds, hydrocarbons and CO, as claimed in any of claims 1 to 12, characterized in that the reactor (19) equipped with catalyst (20) is disposed in the exhaust gas stream behind the boiler (27) and before the air preheater (26).
